(19) United States
(12) Patent Application Publication
(10) Pub. No.: US 2008/0013158 A1
(43) Pub. Date: Jan. 17, 2008

(54) Perspective switching optical device for 3D semiconductor inspection

(76) Inventor: Mark Richard Shires, Glendale, WI (US)

Correspondence Address: Mark Shires;c/o International Product Tech., 3100 S. 166th St., New Berlin, WI, 53151, US

(21) Appl. No.: 11/823,754

(22) Filed: Jun. 28, 2007

Related U.S. Application Data
(60) Provisional application No. 60/818,049, filed on Jun. 30, 2006.

(51) Int. Cl. G02F 1/29

(52) U.S. Cl. 359/299

(57) ABSTRACT

An optical system for camera-based 3D inspection of semiconductor devices that provides two different perspectives of a device by switching the color of the light source is disclosed. The system presents a camera with a first view when one color of light is on, and a different perspective view when a different color of light is on.

### BACKGROUND—FIELD OF THE INVENTION

Electronic devices are commonly inspected in three-dimensions by machine vision systems to ensure that their electrical contacts are within sufficient tolerances to properly solder to a printed circuit board. The present invention is a convenient optical system for inspecting electronic devices such as BGA (Ball Grid Array) devices, LCC (Leadless chip carrier) devices or leaded devices using stereoscopic imaging.

### BACKGROUND—PRIOR ART

Camera-based machine vision 3D inspection systems of electronic semiconductor devices have been in use for years. Such systems measure the contact locations of semiconductors in 3D by imaging two different perspectives of the BGA device.

Typically two cameras are used to create stereo images. U.S. Pat. No. 6,778,282 to Smets (2004) discloses such a system. One camera is positioned for a plan-view perspective and another camera is positioned at an angle to provide an oblique perspective. The main problem with this approach is that using two cameras is expensive because of the redundant equipment required. Two cameras, two lenses, two sets of cables and often two frame grabbers are needed. Additionally the setup or maintenance required is doubled, as both lenses need focusing and both cameras need aligning. Finally, the space requirements for two cameras is often difficult to accommodate on a semiconductor handling machine.

FIG. 1 illustrates this prior art method in which two cameras are used to inspect a BGA device. The first camera 1 has a lens 2 and views the device 7 via an on-axis beam path 3. A ringlight comprising Light Emitting Diodes (LEDs) 9 (just 2 LEDs are depicted, however an complete circle of LEDs surrounds the device) emit rays of light 10 toward the device. A second camera 4 has a lens 5 and views the device via an oblique beam path 6. The resulting camera 1 on-axis image of a typical BGA device looks like FIG. 2. Each properly shaped BGA ball reflects the ringlight to produce a ring or circle 31 on its surface. Thus, nine circles appear, one for each ball on the BGA device. The resulting oblique image produced by camera 4 looks like FIG. 3. Each ball reflects only a portion of the ringlight and thus a semicircular ring 32 appears on each ball.

Another approach of the prior art is to use one camera with a Field Of View (FOV) large enough that it includes a mirror in addition to the BGA device. In the mirror an oblique view of the device is seen. U.S. Pat. Nos. 6,862,365, 6,915,006, 6,915,006, 7,079,678, and 7,085,411 to Beaty (2005-2006) utilize this method as illustrated in FIG. 4. Camera 1 has a lens 2 and views the device 7 via an on-axis beam path 3. A mirror 11 reflects ray 6 from an oblique perspective to be directed as ray 12 toward the camera. The resulting image is depicted in FIG. 5. This approach diminishes the resolution of the camera on the device and therefore the measurement accuracy. Additionally, as inspection requirements change to inspect larger or smaller devices, the mirror location must be adjusted to remain close to the device and the centerline adjustment of the camera often requires adjustment in order to minimize the FOV to optimize measurement accuracy with this method.

### SUMMARY OF THE INVENTION

The present invention is a color-dependent optical switch for consecutively imaging 2 perspectives of a BGA device with a single camera. By illuminating the device with one color of light the on-axis image is seen by the camera. Utilizing a different color of light presents an oblique image to the camera.

To attain this, the present invention generally comprises a light source of a limited spectral range, a second light source of a limited spectral range that is different than the range of the first light source, an optical element that transmits light of substantially the first spectral range and reflects light of substantially the second spectral range, and two reflecting surfaces. These optical elements are arranged such that when only the first light source is turned on, a camera positioned to view a device illuminated by the light source sees the device from a first perspective. Additionally, when only the second light source is turned on the camera sees the device from a second perspective. Further, the beampath length from the camera to the device being inspected is roughly identical regardless of the spectrum of light used so that the device is in focus for both perspectives.

A primary object of the present invention is to provide 2 switchable perspectives of a BGA device that will overcome the shortcomings of the prior art devices, notably to utilize a single camera to save on equipment cost and to optimize the usage of the resolution to increase measurement accuracy. Another object is to minimize changeover time and adjustments required to change the system to inspect other smaller or larger BGA devices with changing the FOV. The invention additionally provides for both optical paths to be roughly equivalent in length so that both perspectives are in focus. Both perspectives can also be substantially centered in the FOV for convenience. A final object is to provide an alternate method of measuring other electronic semiconductor devices such as LCC devices and leaded devices.

### BRIEF DESCRIPTION OF THE DRAWINGS

FIG. 1 is a side section view of prior art utilizing two cameras to produce 2 perspectives.

FIG. 2 is a camera image of the prior art depicted in FIG. 1.

FIG. 3 is a camera image of the prior art depicted in FIG. 1.

FIG. 4 is a side section view of prior art utilizing one camera and one mirror to produce two perspectives.

FIG. 5 depicts a single camera image of the prior art shown in FIG. 4.

FIG. 6 is a side section view of the invention with red light turned on.

FIG. 7 is a camera image of the invention in the state depicted in FIG. 6.

FIG. 8 is a side section view of the invention with blue light turned on.

FIG. 9 is a camera image of the invention in the state depicted in FIG. 8.

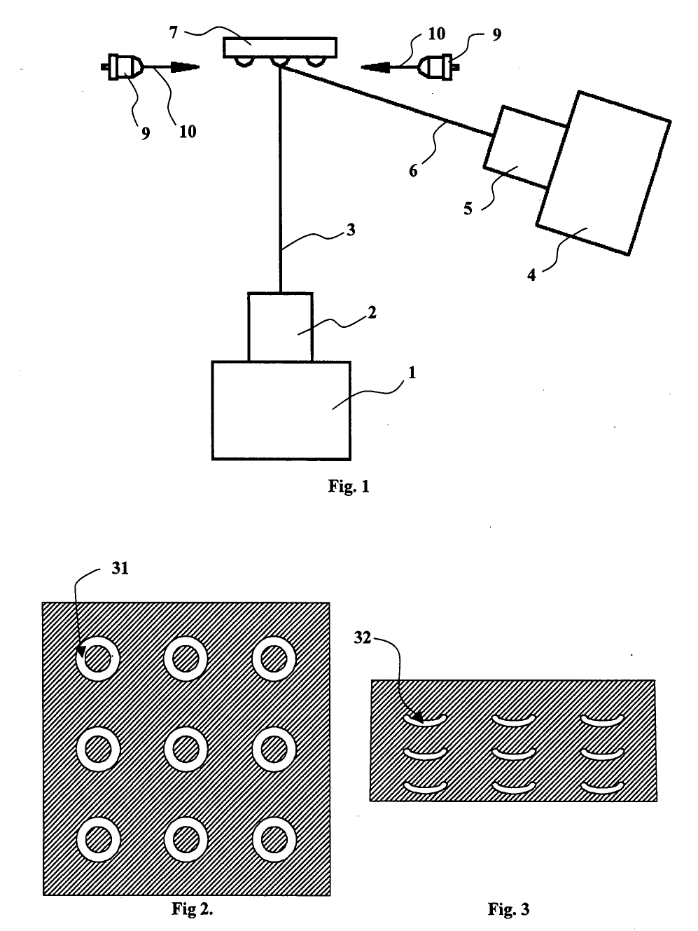

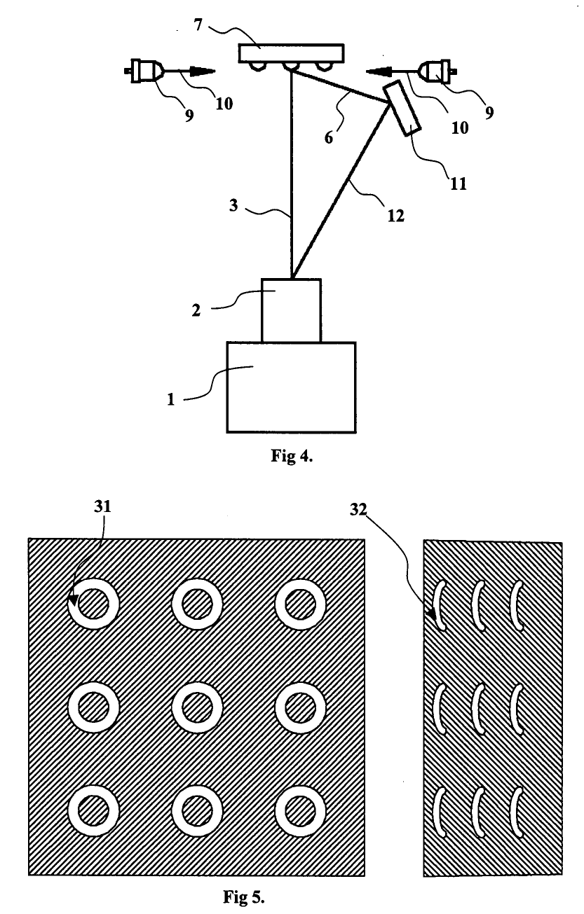

### DETAILED DESCRIPTION OF THE INVENTION

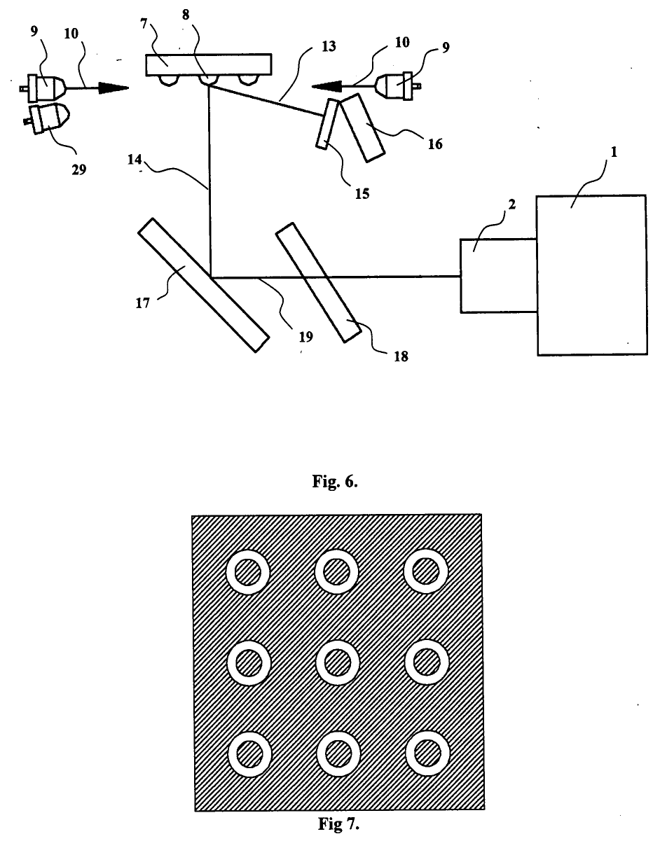

FIG. 6 illustrates a preferred embodiment of the invention. A ringlight of red LEDs 9 encircles the device 7 in the inspection area. A semicircle of blue LEDs 29 partially encircles the device. This semicircle of blue LEDs is opposite the camera. A mirror 17 is positioned below the device at a 45 degree angle to fold the beampath by 90 degrees. A camera 1 and lens 2 are positioned to view the image reflected off of this reflective surface. Between the camera 1 and the reflective surface 17 is a dichroic mirror 18 that allows substantially red light to pass thru while reflecting substantially blue light.

To the right of the inspection area is a dichroic filter 15 which only transmits substantially blue light while reflecting other frequencies of light. Further to the right is a mirror 16 which reflects light downwards toward dichroic mirror 18.

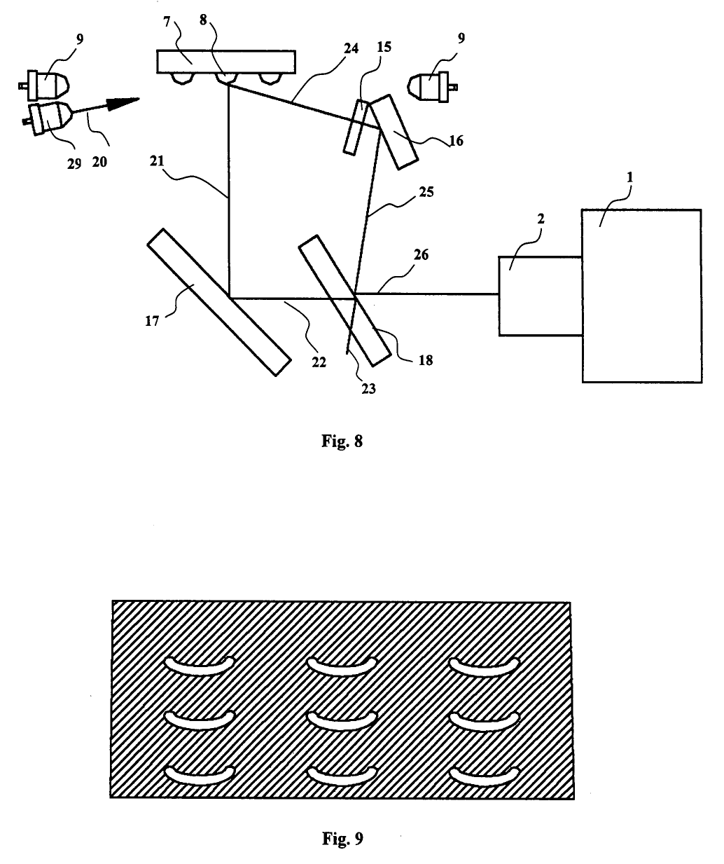

When the red LEDs 9 are energized and the blue LEDs 29 are off, light rays 10 illuminate device 7. Light reflects off of the device in various directions. Considering ball 8 on device 7, there are two possible beam paths that could allow light to be seen by the camera, but only one that allows the red light to be seen. Light ray 13 reflecting from ball 8 toward the blue filter 15 is not allowed to pass thru the filter. However, light ray 14 reflecting from ball 8 is incident on mirror 17, reflects as ray 19 and passes thru dichroic mirror 18 into camera lens 2 producing an image similar to FIG. 7.

When the blue LEDs 29 are energized and the red LEDs 9 are off, light ray 20 illuminates device 7 as shown in FIG. 8. Considering ball 8 on device 7, light reflects in various directions but only one of two optical paths allows light to be seen by the camera. Light ray 21 reflecting downward is incident on mirror 17 and reflects as ray 22. Ray 22 passes thru the nonreflective surface of the dichroic mirror, but when it is incident upon the dichroic coating it cannot pass thru but is reflected out of the system as ray 23. However, ray 24 that is reflected off of ball 8 passes thru blue filter 15 to be incident on mirror 16 which reflects the light as ray 25. Ray 25 is incident on dichroic mirror 18 as ray 26 which then enters into the camera lens producing an image similar to FIG. 9. The angles of all the reflecting surfaces are angled such that ray 26 is substantially coaxial with ray 19 of FIG. 6. Also, the reflecting surfaces are positioned such that the distance traveled by the blue ray that enters the camera lens in FIG. 8 is substantially identical to the distance traveled by the red ray that enters the lens in FIG. 6. Therefore ball 8 can be in focus when illuminated with either light source. And finally, by fixing mirror 17, filter 15, and dichroic mirror 18, the perspective angle and beam path length can be finely and conveniently adjusted by tilting and moving only mirror 16.

The red LED ringlight 9 consists of a 360 degree circle of red LEDs. The ringlight could consist of other light sources such as filament bulbs or gas bulbs or some other light source. The ringlight could utilize a fiber optics or a light pipe or other means to deliver light to the circle around the device. The ringlight need not be red, but it must be of limited range so that it can be separated from the other light source. The light source could comprise a broadband white light source with a color filter to limit its frequency range so that it substantially produces at least one unique frequency of light not produced by the other light source and substantially doesn't produce at least one frequency of light that is produced by the other light source.

The blue LEDs 29 need not be blue, but must be differentiated from light source 9 by a unique color spectrum. Also, this semicircular light source need not subtend exactly 180 degrees, but could be as little as 1 degree to still create a spot of light on the bottom of the ball. The light source could be nonLED and it could use fiber optics or lightpipes or other optical means to deliver a band of limited frequency to the device. In the preferred embodiment the center of the semicircle is roughly opposite ray 24 so that the light seen in the oblique view reflects off of the bottom or nearly the bottom of the ball. The light source could comprise a broadband white light source with a color filter to limit its frequency range.

Mirrors 16 & 17 could be any reflecting surface such as a prism, mirror or holographic reflector, so long as they reflect a coherent image. They could be frequency specific reflectors. Mirror 17 need not be exactly below device and need not reflect light by exactly 90 degrees. Other angles can be used and still embody the invention.

Filter 15 could be a dichroic mirror or a gel filter or any other type of optical filter that can selectively prohibit light of specific frequencies from passing. This filter is not required but is preferred in order to correct for non-desired frequencies that may reflect off of dichroic mirror 18.

Dichroic mirror 18 is a clear polished substrate with a dichroic coating on one surface. The coating could transmit and reflect different colors than mentioned herein so long as it is matched with the colors of light sources used.

The camera 1 could be any of a variety of electronic machine vision cameras such as a Sony XC-ST50 or a Basler a202k or any other make and model that can electronically image in real-time.

Another embodiment of the invention substitues a color camera for the black and white camera. Both light sources are energized simultaneously and the color camera takes a snapshot. The color camera provides a red image that yields one perspective, and a blue image that yields the second desired perspective. This embodiment is advantageous in that the device can be inspected with one snapshot. With a very short shutter time or by strobing the lights the device can be inspected on the fly (as it moves). This is helpful for high speed inspection.

What is claimed is:

1. An optical switch for sequentially switching the viewing perspective that an electronic camera sees when looking through the switch, said switch comprising:
a) a first light source capable of emitting light of a specific first frequency range having at least one frequency not contained in a second light source,
b) a said second light source capable of emitting light of a specific second frequency range having at least one frequency not contained in said first light source,
c) a first reflecting surface for folding a first optical path,
d) a frequency specific reflecting surface that transmits a frequency of light produced by said first light source but not produced said second light source and that reflects a frequency of light produced by said second light source but not produced said first light source,
e) a second reflecting surface for folding a second optical path so as to substantially intersect with said first optical path and simultaneously intersect with said frequency specific reflecting surface,
f) positioning said frequency specific reflecting surface so as to combine said first and said second optical paths,
g) arranging said first and second reflecting surfaces so the distances traveled by each optical path is substantially equivalent.

2. An optical switch as in claim 1 where said first reflecting surface and said frequency specific reflecting surface are fixed but the location and tilt of said second reflecting surface is adjustable so that the perspective angle and the beam path length of the corresponding optical path can be adjusted.

3. An optical switch as in claim 1 wherein a frequency corrective filter is placed in the second optical path.

4. A method for sequentially switching the viewing perspective that an electronic camera sees without moving optics or the camera but by energizing different light sources, said method comprising:
a) illuminating an inspection area with a first light source capable of emitting light of a first frequency not contained in a second light source while not illuminating said inspection area with a second light source, said second light source capable of emitting light having at least one frequency not contained in said first light source,
b) positioning a first reflecting surface for folding a first optical path,
c) positioning a frequency specific reflecting surface that substantially transmits a frequency of light from said first light source but substantially reflects a frequency of light from said second light source,
d) positioning a camera and lens to image an object in the inspection area,
e) positioning a second reflecting surface for folding a second optical path so as to substantially intersect with said first optical path at the location of said frequency specific reflecting surface,
f) acquiring an image of said object with said first light source providing a first perspective,
g) ceasing to illuminate said inspection area with said first light source and begin illuminating inspection area with said second light source,
h) acquiring an image of said object with said second light source providing a second perspective.

5. The method of claim 4 which includes arranging said first and second reflecting surfaces so that the distances traveled by each optical path is substantially equivalent.

6. The method of claim 4 that is used to obtain stereo images of electronic semiconductor devices in order to measure the position of electrical contacts in three-dimensions.

7. An optical system for 3D measurement inspection of electronic semiconductor devices comprising an optical switch for sequentially switching the viewing perspective that an electronic camera sees when looking through the switch, said switch comprising:
a) a first light source capable of emitting a first frequency of light substantially not contained in a second light source,
b) a said second light source capable of emitting a second frequency of light substantially not contained in said first light source,
c) a first reflecting surface for folding a first optical path,
d) a frequency specific reflector placed in said first optical path wherein said reflector substantially transmits said first frequency of light produced by said first light source and that substantially reflects said frequency of light produced by said second light,
e) a second reflecting surface for folding a second optical path so as to substantially intersect with said first optical path,
f) positioning said frequency specific reflector at the intersection of said first and second optical paths and angled so as to combine said first and said second optical paths,
g) arranging said first and second reflecting surfaces and said frequency specific reflector so that the distances traveled by each optical path is substantially equivalent.

8. An optical system as in claim 7 where said first reflecting surface and said frequency specific reflector are fixed but the location and tilt of said second reflecting surface is adjustable so that the perspective angle and the beam path length of the corresponding optical path can be easily adjusted.

9. An optical system as in claim 7 that further comprises a frequency corrective filter in the second optical path.

10. An optical system as in claim 7 for measuring features of a BGA semiconductor device in 3-dimensions using triangulation.

11. A method for 3D measurement inspection of electronic semiconductor devices by sequentially obtaining stereo viewing perspectives by sequentially energizing different light sources, said method comprising:
a) illuminating an electronic semiconductor device with a first light source capable of emitting light of a first frequency not contained in a second light source while not illuminating said electronic semiconductor device with a second light source, said second light source capable of emitting light having at least one frequency not contained in said first light source,
b) positioning a first reflecting surface for folding a first optical path,
c) positioning a frequency specific reflecting surface that substantially transmits a frequency of light from said first light source but substantially reflects a frequency of light from said second light source,
d) positioning a camera and lens to image said electronic semiconductor device,
e) positioning a second reflecting surface for folding a second optical path so as to substantially intersect with said first optical path at the location of said frequency specific reflecting surface,
f) acquiring an image of said device with said first light source providing a first perspective,
g) stop illuminating said inspection area with said first light source and begin illuminating inspection area with said second light source,
h) acquiring an image of said device with said second light source providing a second perspective.

12. The method of claim 11 which includes arranging said first and second reflecting surfaces so the distances traveled by each optical path is substantially equivalent.

13. A method for 3D measurement inspection of electronic semiconductor devices by obtaining stereo viewing perspectives by utilizing different light sources, said method comprising:
a) illuminating an electronic semiconductor device with light,
b) positioning a first reflecting surface for folding a first optical path,
c) positioning a second reflecting surface for folding a second optical path so as to substantially intersect with said first optical path,
d) positioning a frequency specific reflecting surface that substantially transmits a frequency of light while simultaneously substantially reflecting a different frequency of light, said frequency specific reflecting surface being positioned at the intersection of said first and second optical paths and angled so as to combine said first and said second optical paths,
e) positioning a color camera and lens to image said electronic semiconductor device along said combined optical paths,
f) acquiring from said color camera an image of one color field corresponding to said transmitted frequency of light,
g) acquiring from said color camera an image of another color field corresponding to said reflected frequency of light,
h) arranging said first and second reflecting surfaces so that the distances traveled by each optical path is substantially equivalent and thus in focus to the camera.

14. The method of claim 13 wherein the light source is strobed so that both perspective images of devices can be taken while the device is in motion.
